(19) United States
(12) Patent Application Publication
(10) Pub. No.: US 2010/0318422 A1
(43) Pub. Date: Dec. 16, 2010

(54) METHOD FOR RECOMMENDING INFORMATION OF GOODS AND SYSTEM FOR EXECUTING THE METHOD

(75) Inventors: Min Uk Kim, Seoul (KR); Se Dong Nam, Seoul (KR); Do Hwan Kang, Seoul (KR)

Correspondence Address: H.C. PARK & ASSOCIATES, PLC, 8500 LEESBURG PIKE, SUITE 7500, VIENNA, VA, 22182, US

(73) Assignee: NHN CORPORATION, Kyunggi-do (KR)

(21) Appl. No.: 12/446,412

(22) PCT Filed: Nov. 14, 2007
(86) PCT No.: PCT/KR2007/005707

§ 371 Date: Apr. 20, 2009

(30) Foreign Application Priority Data
Nov. 20, 2006 (KR) 10-2006-0114750

(51) Int. Cl. G06Q 30/00; G06F 3/048

(52) U.S. Cl. 705/14.53; 715/769

(57) ABSTRACT

A method of recommending product information and a system for executing the method are provided. A method of recommending product information via an information recommendation agent installed in a user terminal, the method including the steps of: recognizing at least one product selected via the user terminal; receiving at least one of search data and condition data of the at least one product via the user terminal, associating the at least one of the search data and the condition data with the at least one product, and storing and maintaining the at least one of the search data and the condition data; searching for the product information of the at least one product by using the search data; and displaying the product information corresponding to the condition data via the user terminal.

### TECHNICAL FIELD

The present invention relates to a method of recommending product information and a system for executing the method, and more particularly, to a method of automatically recommending product information of a product by using a product code, a product name, a model name, and the like of the product recognized by an information recommendation agent installed in a user terminal and a system for executing the method.

### BACKGROUND ART

Before the Internet became commonly used, electronic commerce (e-commerce) existed in various forms including exchanging documents between enterprises by using an electronic scheme, home shopping—home banking using PC communication, and the like. However, as the Internet has become popularized, the e-commerce is considered as being related to transactions over the Internet.

The e-commerce in a narrow meaning denotes that a transaction for a product is conducted in real time via a store accessed through a homepage on the Internet. The product of the transaction includes actual things such as an electronic part and services such as a long-distance education and a medical diagnosis. Also, the product includes a digital product such as news, audio, and software, and importance of the digital product increases in the e-commerce. The e-commerce in a broad meaning includes transactions with consumers and activities related to transactions, performed by all institutions related to the transactions, such as a provider, a financial institution, a governmental institution, and a transportation institution.

In this instance, when the e-commerce is performed using a web-browser, a web-server used for most e-commerce requires a user to use a cookie. In this instance, the cookie denotes a small-sized (less than or equal to 4 kB) file including information intermediating between a web-site and a computer of an Internet user. Items selected by the user in an Internet shopping mall may be entered into the cookie using a shopping basket scheme. This denotes that even though the user becomes disconnected while shopping and accesses again later, the user does not need to search for and select contents to put into the cookie (the shopping basket) again.

FIG. 1 illustrates a shopping basket function according to a conventional art.

When a user terminal 101 accesses a web page 102, the web page 102 transfers information of the web page 102 to a web browser of the user terminal 101. The information is stored in the user terminal 101, and when later accessing the same web page 102, the user terminal 101 reports, to a web server 103, information related to a user.

In this instance, the information may be performed using a cookie 104 described above, and a shopping basket function may be embodied using the cookie. The web page 102 including a shopping mall page provides a function 106 of adding an identifier of product information 105 to the cookie 104, and the product information 105 is stored in the user terminal 101 via the cookie 104.

When subsequently accessing the web page 102 via the user terminal 101 again, the web server 103 may receive the cookie 104 stored in the user terminal 101 and provide the user terminal 101 with the product information 105 via the identifier of the product information 105 included in the cookie 104. Accordingly, the product information 105 may be directly provided eliminating a need for searching for the product information 105 previously selected by the user terminal 101 again and selecting the product information 105.

However, the shopping basket function may be limitedly used for only a single web site, and the product information may not be acquired in other web sites including another shopping mall, a price comparison site, and the like using an identifier of the same product. Specifically, there is an inconvenience that the user needs to directly visit another web site in order to acquire the identifier of the same product. Also, there is a problem that the shopping basket function is restricted in use for the shopping basket function provided by the web site entering the product.

### DISCLOSURE OF INVENTION

### Technical Goals

The present invention provides a new technology with respect to a method of recommending product information and a system for executing the method.

The present invention also provides a method of recommending product information and a system for executing the method which enables an information recommendation agent installed in a user terminal to recognize a product selected by the user terminal without being limited to a certain web site, and to search for and analyze the product information of the product in the web site recognizing the product and another web site using an identifier of the same recognized product and information entered via the user terminal.

The present invention also provides a method of recommending product information and a system for executing the method which can recommend only information desired by a user of a user terminal from among the product information retrieved via condition data entered via the user terminal.

The present invention also provides a method of recommending product information and a system for executing the method which can continuously search for the product information and information with respect to contents of an image, a text interesting to a user, and the like, and recommend, to the user, information in accordance with a condition registered by the user.

### Technical solutions

According to an aspect of the present invention, there is provided a method of recommending product information via an information recommendation agent installed in a user terminal, the method including the steps of: recognizing at least one product selected via the user terminal; receiving at least one of search data and condition data of the at least one product via the user terminal, associating the at least one of the search data and the condition data with the at least one product, and storing and maintaining the at least one of the search data and the condition data; searching for the product information of the at least one product by using the search data; and displaying the product information corresponding to the condition data via the user terminal.

In an aspect of the present invention, the at least one product is selected by the user terminal via a drag and drop event to the information recommendation agent, the drag and drop event being with respect to at least one of an image and a text associated with the at least one product in a web page displayed by the user terminal.

In an aspect of the present invention, the step of recognizing includes the steps of: extracting at least one of a product code, a product name, and a model name of the at least one product in the web page via the at least one of the image and the text; and recognizing the at least one of the product code, the product name, and the model name as the at least one product.

In an aspect of the present invention, the step of recognizing includes the steps of: receiving at least one of a product code, a product name, and a model name of the at least one product via the user terminal; and recognizing the at least one of the product code, the product name, and the model name as the at least one product.

According to another aspect of the present invention, there is provided a method of recommending information via an information recommendation agent installed in a user terminal, the method including the steps of: recognizing at least one content selected via the user terminal; providing a data entry function of receiving search data and condition data of the at least one content via the user terminal; associating, with the at least one content, at least one of the search data and the condition data entered via the data entry function, and storing and maintaining the at least one of the search data and the condition data; searching for content information associated with the at least one content by using the search data; and displaying the content information based on the condition data via the user terminal.

### BRIEF DESCRIPTION OF DRAWINGS

FIG. 1 illustrates a shopping basket function according to a conventional art;

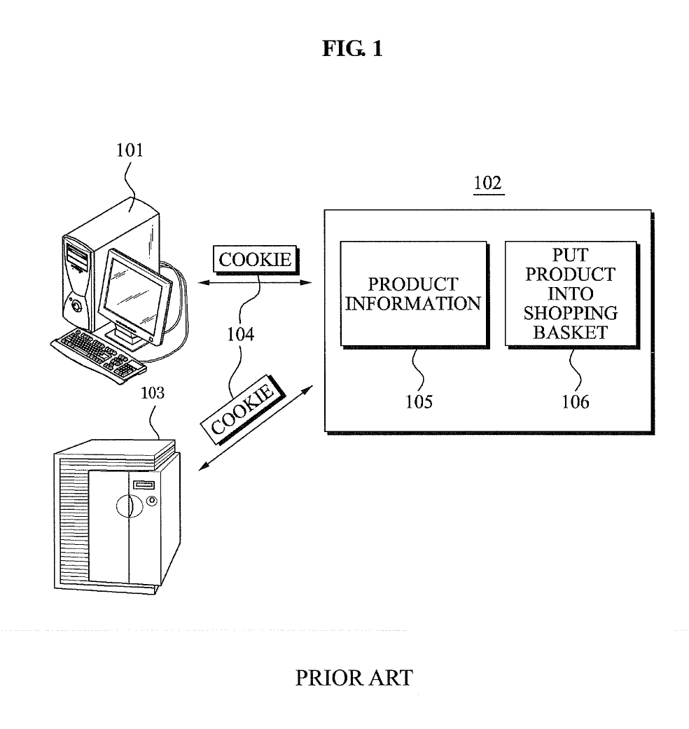

FIG. 2 is a diagram illustrating an overview of a method of recommending product information via an information recommendation agent according to a first exemplary embodiment of the present invention;

FIG. 3 is a flowchart illustrating a method of recommending product information via an information recommendation agent installed in a user terminal according to a first exemplary embodiment of the present invention;

FIG. 4 illustrates an example of a method of recognizing a product and recommending product information via the recognized product according to an exemplary embodiment of the present invention;

FIG. 5 is a block diagram illustrating an internal configuration of an information recommendation agent recommending product information according to a second exemplary embodiment of the present invention;

FIG. 6 is a flowchart illustrating a method of recommending information via an information recommendation agent installed in a user terminal according to a third exemplary embodiment of the present invention; and

FIG. 7 is a block diagram illustrating an internal configuration of an information recommendation agent being installed in a user terminal and recommending information according to a fourth exemplary embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

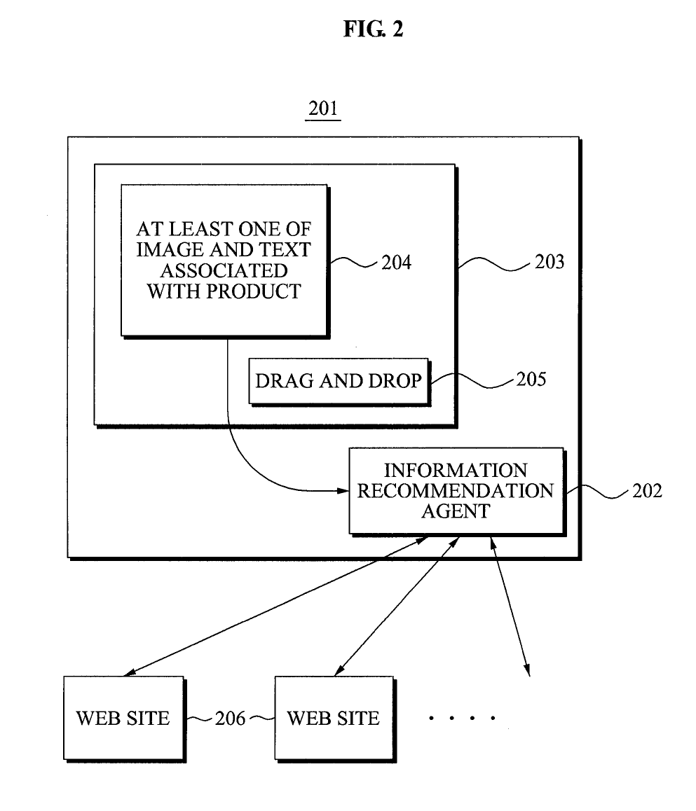

FIG. 2 is a diagram illustrating an overview of a method of recommending product information via an information recommendation agent according to a first exemplary embodiment of the present invention.

A reference number 201 illustrates an example of screens displayed via a user terminal. As illustrated in FIG. 2, an information recommendation agent 202 installed in the user terminal is displayed on a specific area of the screen, and a user of the user terminal may register, in the information recommendation agent 202, at least one of an image and a text associated with a desired product 204 in a web page 203 displayed on the screen via a drag and drop 205.

Specifically, the information recommendation agent 202 may verify a drag and drop 205 event to the information recommendation agent 202, and recognize the at least one of the image and the text 204 associated with the event.

The information recommendation agent 202 may continuously search for at least one of the web page 203 and a plurality of other web sites 206, and recommend the product information of the product to the user via the recognized product. Also, when condition data of displaying the product information is registered in the information recommendation agent 202, the product information may be analyzed and only the product information in accordance with the condition data may be recommended to the user.

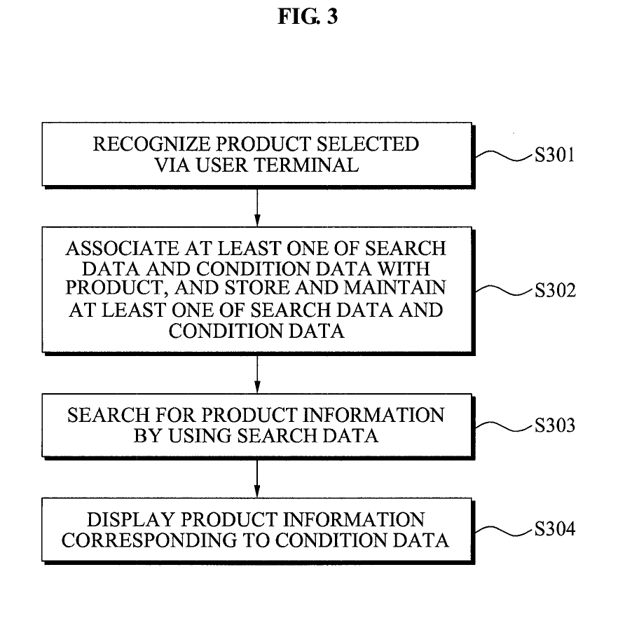

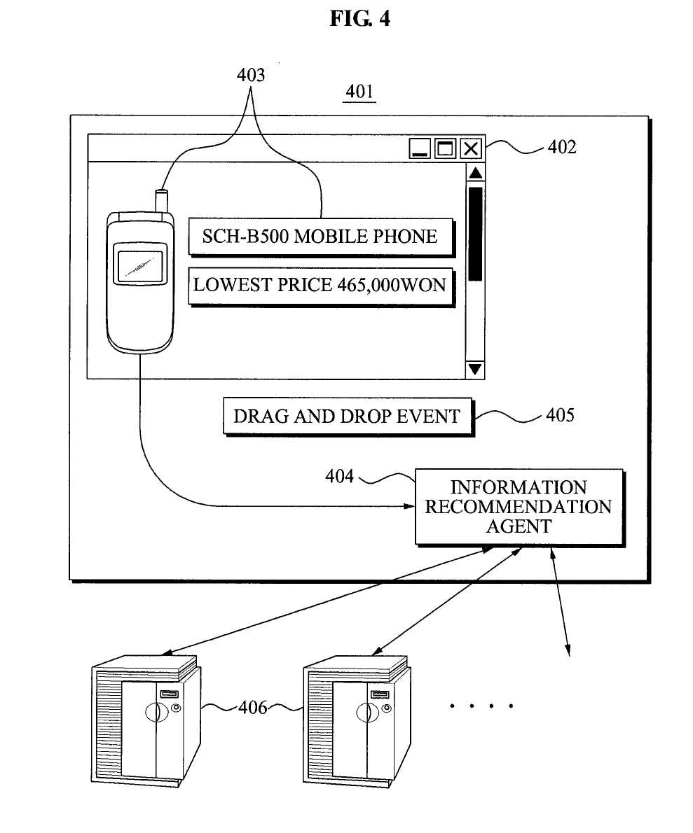

As described above, a method of recommending product information using an information recommendation agent is described in detail with reference to FIG. 3 and FIG. 4.

FIG. 3 is a flowchart illustrating a method of recommending product information via an information recommendation agent installed in a user terminal according to a first exemplary embodiment of the present invention.

In operation S301, the information recommendation agent recognizes at least one product selected via the user terminal. In this instance, the at least one product is selected by the user terminal via a drag and drop event to the information recommendation agent, the drag and drop event being with respect to at least one of an image and a text associated with the at least one product in a web page displayed by the user terminal.

The information recommendation agent may extract at least one of a product code, a product name, and a model name of the at least one recognized product in the web page via the at least one of the image and the text, and recognize the at least one of the product code, the product name, and the model name as the at least one product.

Also, the at least one of the product code, the product name, and the model name of the at least one product may be entered via the user terminal without using the drag and drop event, and the at least one of the product code, the product name, and the model name may be recognized as the at least one product.

In operation 5302, the information recommendation agent receives at least one of search data and condition data of the at least one product via the user terminal, associates the at least one of the search data and the condition data with the at least one product, and stores and maintains the at least one of the search data and the condition data. The search data includes an address of a web site to perform a search for the product information via a network and a search interval of the search. Also, the condition data includes at least one of a lowest price of the at least one product entered via the user terminal, and a condition character string associated with the at least one product.

Specifically, the search data may include data concerning which web site is retrieved in order to search for the product information of the at least one product, and data concerning when the search is performed. Also, the condition data may be used for determining whether to recommend the product information to the user of the user terminal via the at least one of the lowest price and the condition character string, the product information being retrieved via the address for each search interval.

In operation S303, the information recommendation agent searches for the product information of the at least one product by using the search data. Specifically, operation S303 may be performed by accessing the web site via the address for each search interval and searching for the web site using the product code, the product name, the model name, and the like.

In this instance, when the search data associated with the at least one product does not exist, the information recommendation agent may search for the product information for each search interval set as a default value via the at least one of the product code, the product name, and the model name in the web page selecting the at least one product.

In operation S304, the information recommendation agent displays the product information corresponding to the condition data via the user terminal. In this instance, the information recommendation agent may verify whether the product information includes at least one of a price lower than or equal to the lowest price and the condition character string, and display only the product information including at least one of the price and the condition character string via the user terminal.

Specifically, a price of the at least one product, the price being desired by the user, may be included in the condition data as the lowest price. When the price of the at least one product is lower than or equal to the lowest price, the information recommendation agent may recommend the product information desired by the user by displaying the product information. Also, the user may acquire price information of the at least one product and the product information including desired contents by establishing the condition character string as a keyword and recommending the product information including the keyword.

The lowest price may be used for recommending the product information in web sites including a shopping mall site, a price comparison site, and the like, and the condition character string may be used for acquiring various information of the at least one product in a web site displaying an article, a blog, a bulletin board, and the like.

In this instance, when the condition data associated with the at least one product does not exist, whether the product information includes a price lower than or equal to a price at a time of selecting the at least one product may be verified by using the price at the time of selecting the at least one product. Specifically, when the condition data of the at least one product is not entered, the information recommendation agent may store a price at a time when the drag and drop event of the at least one product is generated, and use the price as the condition data.

As described above, the information recommendation agent installed in the user terminal may recognize a product selected by the user terminal without being limited to a certain web site, and may search for and analyze product information of the product in the web site recognizing the product and another web site using an identifier of the same recognized product and information entered via the user terminal. Also, the information recommendation agent installed in the user terminal may recommend only information desired by a user of the user terminal from among the product information retrieved via condition data entered via the user terminal.

Also, since the information recommendation agent is not limited to a certain site for performing a search and analysis, a shopping basket function used by a plurality of shopping malls may be integratedly managed.

FIG. 4 illustrates an example of a method of recognizing a product and recommending product information via the recognized product according to an exemplary embodiment of the present invention.

A reference number 401 denotes a portion of a screen displayed via a user terminal. Here, an information recommendation agent 404 may recognize a product desired by a user of the user terminal via a drag and drop event 405 to the information recommendation agent 404, the drag and drop event 405 being with respect to at least one of an image and a text 403 of a web page 402 displayed on the screen.

In this instance, the information recommendation agent 404 may extract at least one of a product code, a product name, and a model name such as “SCH-B500” via the at least one of the image and the text 403, and recognize the product via the at least one of the product code, the product name, and the model name. Alternatively, the at least one of the product code, the product name, and the model name may be extracted via a source of the at least one of the image and the text 403, and the web page 402.

As described above, the information recommendation agent 404 recognizing the product may provide the user with a data entry function of receiving search data and condition data via the user terminal, and receive at least one of the search data and the condition data. Also, the information recommendation agent 404 accesses a web server 406 using an address of the web site for each search interval included in the search data, and searches for the product information of the product via the at least one of the product code, the product name, and the model name.

When the search data is not entered, the information recommendation agent 404 searches for the product information for each search interval set as a default value via the web page 402 extracting the at least one of the product code, the product name, and the model name of the product. Specifically, when the search data is not entered via the data entry function, the information recommendation agent 404 may search for the product information by adding the default value to the search interval and adding an address of the web page 402 to an address of the web site.

As described above, the retrieved product information is analyzed by the information recommendation agent 404 using the condition data, and is recommended to the user by displaying the product information via the user terminal. In this instance, when the condition data includes the lowest price, the information recommendation agent 404 verifies whether the product information includes a price lower than or equal to the lowest price. When the condition data includes the condition character string, the information recommendation agent 404 verifies whether the product information includes the condition character string. As described above, the product information satisfying the condition data is displayed via the user terminal.

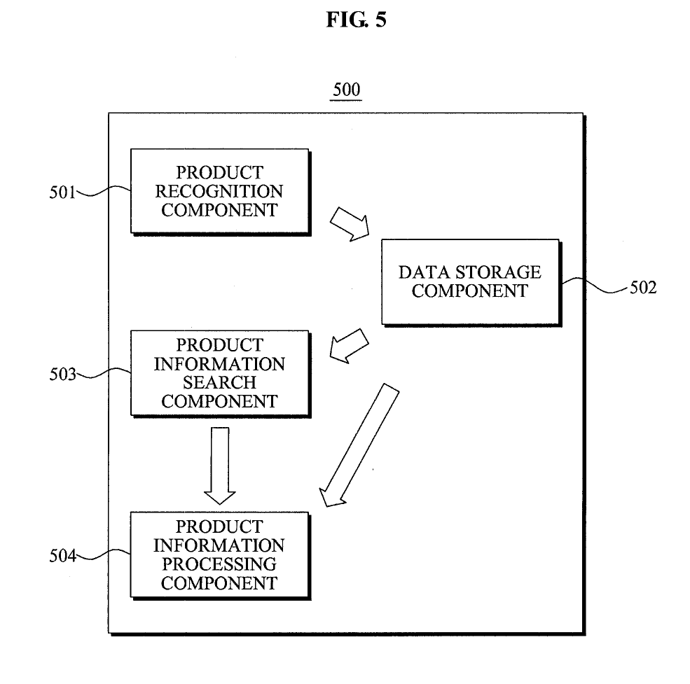

FIG. 5 is a block diagram illustrating an internal configuration of an information recommendation agent 500 recommending product information according to a second exemplary embodiment of the present invention. As illustrated in FIG. 5, the information recommendation agent 500 may include a product recognition component 501, a data storage component 502, a product information search component 503, and a product information processing component 504.

The product recognition component 501 recognizes at least one product selected via the user terminal. In this instance, the at least one product is selected by the user terminal via a drag and drop event to the information recommendation agent, the drag and drop event being with respect to at least one of an image and a text associated with the at least one product in a web page displayed by the user terminal.

In order to select the at least one product, the product recognition component 501 may include an extraction component (not illustrated) configured to extract at least one of a product code, a product name, and a model name of the at least one product in the web page via the at least one of the image and the text, and a recognition component (not illustrated) configured to recognize the at least one of the product code, the product name, and the model name as the at least one product.

The data storage component 502 receives at least one of search data and condition data of the at least one product via the user terminal, associates the at least one of the search data and the condition data with the at least one product, and stores and maintains the at least one of the search data and the condition data. In this instance, the search data includes an address of a web site to perform a search for the content information via a network and a search interval of the search. Also, the condition data includes at least one of a lowest price of the at least one product entered via the user terminal, and a condition character string associated with the at least one product.

The product information search component 503 searches for the product information of the at least one product by using the search data. For this, the product information search component 503 may include an access component (not illustrated) configured to access the web site via the address for each search interval, and a search component (not illustrated) configured to search for the product information in the web site via at least one of a product code, a product name, and a model name of the at least one product.

The product information processing component 504 displays the product information corresponding to the condition data via the user terminal. In this instance, the product information processing component 504 may include a condition data verification component (not illustrated) configured to verify whether the product information includes at least one of a price lower than or equal to the lowest price and the condition character string, and a display component (not illustrated) configured to display the product information including at least one of the price and the condition character string via the user terminal.

As describe above, when the information recommendation agent 500 is used, an information recommendation agent installed in a user terminal may recognize a product selected by the user terminal without being limited to a certain web site, and search for and analyze product information of the product in the web site recognizing the product and another web site using an identifier of the same recognized product and information entered via the user terminal.

Also, since the limitation to the certain web site may be eliminated when recognizing, searching for, and analyzing the product, a shopping basket function of a separate shopping mall may be integratedly managed.

Also, the information recommendation agent installed in the user terminal may recommend only information desired by a user of the user terminal from among the product information retrieved via condition data entered via the user terminal.

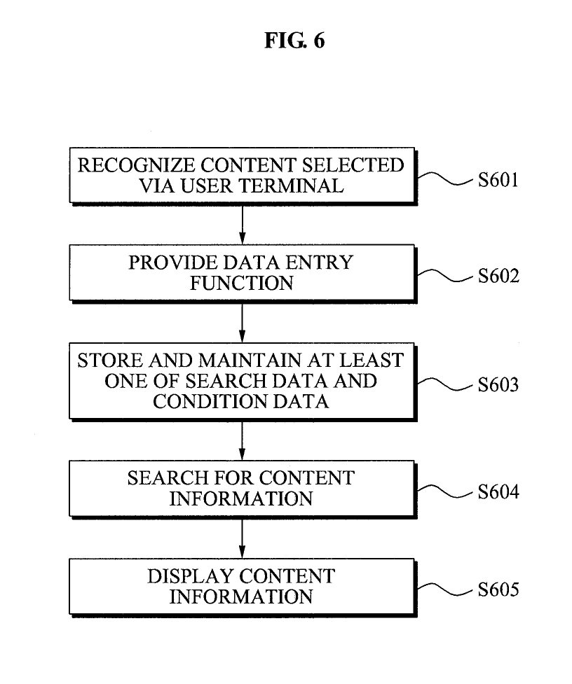

FIG. 6 is a flowchart illustrating a method of recommending information via an information recommendation agent installed in a user terminal according to a third exemplary embodiment of the present invention.

In operation S601, the information recommendation agent recognizes at least one content selected via the user terminal. In this instance, the at least one content is selected by the user terminal via a drag and drop event to the information recommendation agent, the drag and drop event being with respect to at least one of an image and a text in a web page displayed by the user terminal, the web page including the at least one of the image and the text.

Specifically, a user of the user terminal enables the information recommendation agent to recognize the at least one content by performing a drag and drop to the information recommendation agent, the drag and drop being with respect to the at least one of the image and the text desired while web surfing.

In operation S602, the information recommendation agent provides a data entry function for receiving search data and condition data of the at least one content via the user terminal. In this instance, the search data includes an address of a web site to perform a search for the content information via a network and a search interval of the search. The condition data includes at least one of a character string and a number entered by a user of the user terminal, and a relation between the number and the content information.

Accordingly, the data entry function may have a predetermined form for receiving the search data and the condition data. Specifically, the data entry function may have a time for the search interval, a field receiving the address, and fields for receiving at least one of the character string, the number, and the relation. Also, the specific search data and the specific condition data may be received by adding an operator including “and”, “or”, and the like between the character string and the number expanding those.

In operation S603, the information recommendation agent associates, with the at least one content, at least one of the search data and the condition data entered via the data entry function, and stores and maintains the at least one of the search data and the condition data. Specifically, in order to recommend the content information of a plurality of contents, the information recommendation agent may associate at least one of the search data and the condition data with the at least one content, and store and maintain the at least one of the search data and the condition data.

In operation S604, the information recommendation agent searches for content information associated with the at least one content by using the search data. In this instance, the information recommendation agent may access the web site via the address for each search interval, and search for the content information via the at least one of the image and the text recognized as the at least one content.

Also, when the search data associated with the at least one content does not exist, the information recommendation agent searches for the content information for each search interval set as a default value via the at least one of the image and the text in the web page selecting the at least one content.

In operation S605, the information recommendation agent displays the content information based on the condition data via the user terminal. In this instance, the content information may include a web page displaying information associated with the at least one of the image and the text, and the information recommendation agent may display, from among the content information in which information is uploaded or changed from a previous search, the web page including at least one of the character string and the number, or displays the web page satisfying the relation between the number and the content information via the user terminal.

For example, only the content information satisfying the condition data that “a stock price” of “company A” is “less than or equal to” “5,000 won” may be displayed via the user terminal from among a plurality of content information retrieved by the search data and the at least one content which respectively includes a web site associated with a stock, that is, “www.stock.com”, every five minutes, as the search interval and the address. Alternatively, only the content information satisfying the condition data being “greater than or equal to” “$60.55” “for each barrel” may be displayed via the user terminal from among a plurality of content information retrieved by the search data and the at least one content which respectively includes a web site associated with an oil price, that is, “www.oilprice.com”, every four hours, as the search interval and the address.

As described above, the information recommendation agent installed in the user terminal may recognize contents selected by the user terminal without being limited to a certain web site, and search for and analyze content information of the contents in the web site recognizing the contents and another web site using an identifier of the same recognized contents and information entered via the user terminal.

Also, the information recommendation agent installed in the user terminal may recommend only information desired by a user of the user terminal from among the content information retrieved via condition data entered via the user terminal, continuously search for information with respect to contents of an image, a text interesting to the user, and the like, and recommend, to the user, information in accordance with a condition registered by the user.

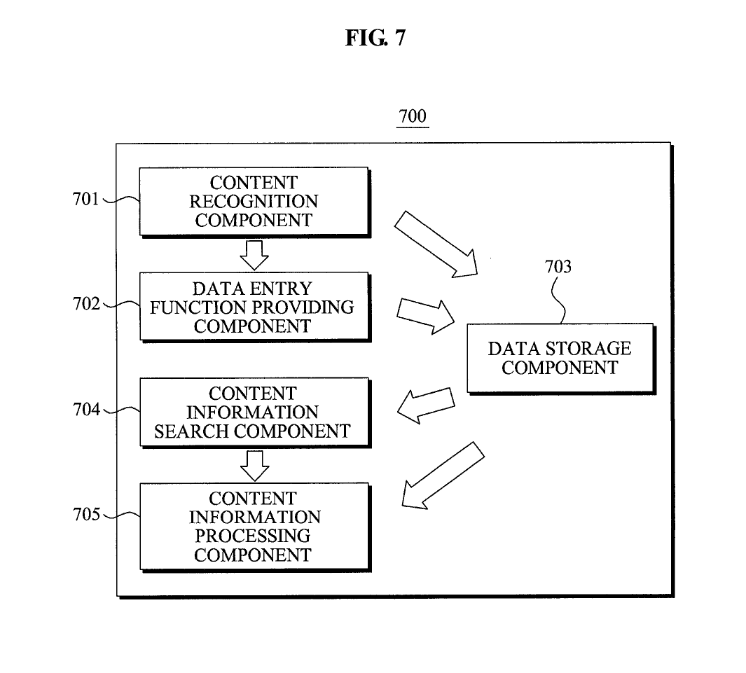

FIG. 7 is a block diagram illustrating an internal configuration of an information recommendation agent 700 being installed in a user terminal and recommending information according to a fourth exemplary embodiment of the present invention. As illustrated in FIG. 7, the information recommendation agent 700 may include a content recognition component 701, a data entry function providing component 702, a data storage component 703, a content information search component 704, and a content information processing component 705.

The content recognition component 701 recognizes at least one content selected via the user terminal. In this instance, the at least one content is selected through the user terminal via a drag and drop event to the information recommendation agent, the drag and drop event being with respect to at least one of an image and a text in a web page displayed by the user terminal, the web page including the at least one of the image and the text, and the content recognition component 701 recognizes the at least one of the image and the text as the at least one content.

The data entry function providing component 702 provides a data entry function of receiving search data and condition data of the at least one content via the user terminal. In this instance, the search data includes an address of a web site to perform a search for the content information via a network and a search interval of the search, and the condition data includes at least one of a character string and a number entered by a user of the user terminal, and a relation between the number and the content information.

The data storage component 703 associates, with the at least one content, at least one of the search data and the condition data entered via the data entry function, and stores and maintains the at least one of the search data and the condition data. Specifically, in order to recommend the content information of a plurality of contents, the data storage component 703 may associate at least one of the search data and the condition data with the at least one content, and store and maintain the at least one of the search data and the condition data.

The content information search component 704 searches for content information associated with the at least one content by using the search data. In this instance, the content information search component 704 may include an access component (not illustrated) configured to access the web site via the address for each search interval, and a search component (not illustrated) configured to search for the content information in the web site via the at least one of the image and the text recognized as the at least one content.

Also, when the search data associated with the at least one content does not exist, that is, when the search data is not entered, the content information search component 704 searches for the content information for each search interval set as a default value via the at least one of the image and the text in the web page where the at least one content is selected.

The content information processing component 705 displays the content information based on the condition data via the user terminal. The content information processing component 705 displays, from among the content information in which information is uploaded or changed from a previous search, content information including at least one of the character string and the number, or displays content information satisfying the relation between the number and the content information via the user terminal.

In this instance, when the condition data does not exist, that is, when the condition data is not entered, the content information processing component 705 may display all the content information retrieved by the content information search component 704.

As described above, the information recommendation agent may continuously search for the product information and information with respect to contents of an image, a text interesting to a user, and the like, and recommend, to the user, information in accordance with a condition registered by the user.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, there is provided a method of recommending product information and a system for executing the method which enables an information recommendation agent installed in a user terminal to recognize a product selected by the user terminal without being limited to a certain web site, and to search for and analyze the product information of the product in the web site recognizing the product and another web site using an identifier of the same recognized product and information entered via the user terminal.

Also, according to the present invention, there is provided a method of recommending product information and a system for executing the method which can recommend only information desired by a user of a user terminal from among the product information retrieved via condition data entered via the user terminal.

Also, according to the present invention, there is provided a method of recommending product information and a system for executing the method which can continuously search for the product information and information with respect to contents of an image, a text interesting to a user, and the like, and recommend, to the user, information in accordance with a condition registered by the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A computer-implemented method of providing personalized product information to a user, the method comprising the steps of:
receiving selection of at least one product from a user;
receiving from the user search condition associated with said at least one product;
storing and maintaining said search condition associated with said at least one product in a memory, said search condition including at least one website to be searched for product information of said at least one product;
periodically searching said at least one website for the product information of the at least one product based upon said search condition and storing search result of said periodical search; and
presenting to the user personalized product information based on said search result and said search condition,
wherein said step of periodically searching is performed by a processor.

2. The method of claim 1, wherein the user is allowed to select the at least one product by utilizing a drag-and-drop graphical user interface.

3. The method of claim 2, wherein the step of receiving selection comprises the steps of:
extracting and identifying at least one of a product code, a product name, and a model name of the at least one product from at least one of graphical image and text selected by the user by utilizing a drag-and-drop graphical user interface.

4. The method of claim 1, wherein the step of receiving selection comprises the steps of:
receiving at least one of a product code, a product name, and a model name of the at least one product from the user.

5. The method of claim 1, wherein said search condition includes at least one of price range of said at least one product and time interval for said periodical search.

6. The method of claim 5, wherein the step of periodically searching comprises the steps of:
accessing said at least one website at each time interval; and
searching said at least one website for the product information.

7. The method of claim 6, wherein the step of periodically searching comprises the step of:
searching said at least one website for the product information at each time interval set as a default value with at least one of a product code, a product name, and a model name when the product information within said price range is not available.

8. The method of claim 1, wherein the search condition includes at least one of a price range for the at least one product, and a condition character string associated with the at least one product.

9. The method of claim 8, wherein the step of presenting comprises the steps of:
verifying whether the search result meets said price range; and
displaying the personalized product information including product information based on said search result and said price range of the search condition.

10. The method of claim 8, wherein the step of displaying comprises the step of:
verifying, by using a price at a time of selecting the at least one product, whether the product information includes a price lower than or equal to the price when the price range of the search condition associated with the at least one product is not available.

11. The method of claim 5, wherein said at least one website includes at least one of a shopping mall website and a price comparison website.

12. A computer-implemented method of providing personalized information via an information recommendation agent application installed in a user terminal, the method comprising the steps of:
receiving selection of at least one content from a user;
receiving from the user search condition associated with said at least one content;
storing and maintaining said search condition associated with said at least one content in a memory, said search condition including at least one website to be searched for content information of said at least one content;
periodically searching said at least one website for said content information associated with the at least one content and storing search result of said periodical search; and
presenting to the user personalized content information based on said search result and said search condition,
wherein the step of periodically searching is performed by a processor.

13. The method of claim 12, wherein the user is allowed to select said at least one content by utilizing a drag-and-drop graphical user interface.

14. The method of claim 13, wherein the step of receiving selection recognizes said at least one content from at least one of graphical image and text selected by the user by utilizing a drag-and-drop graphical user interface.

15. The method of claim 12, wherein the content information includes a web page displaying information associated with the at least one of the image and the text.

16. (canceled)

17. The method of claim 12, wherein the step of periodically searching comprises the steps of:
accessing said at least one website at each time interval; and
searching said at least one website for the content information.

18. The method of claim 17, wherein the step of periodically searching comprises the step of:
searching said at least one website for the content information at each time interval set as a default value with at least one of an image and a text when the content information associated with the at least one content is not available.

19. The method of claim 12, wherein the search condition includes at least one of a character string and a number entered by the user, and a relation between the number and the content information, and
the step of presenting displays, from among the content information in which information is uploaded or changed from a previous search, content information including at least one of the character string and the number, or displays content information satisfying the relation between the number and the content information via a user terminal.

20. One or more storage media having stored thereon a computer program that, when executed by one or more processors, causes the one or more processors to perform acts including:
receiving selection of at least one product from a user;
receiving from the user search condition associated with said at least one product;
storing and maintaining said search condition associated with said at least one product in a memory, said search condition including at least one website to be searched for product information of said at least one product;
periodically searching said at least one website for the product information of the at least one product based upon said search condition and storing search result of said periodical search; and
presenting to the user personalized product information based on said search result and said search condition.

21. A computing system for providing personalized product information to a user, comprising:
a client computer operative to execute program code for receiving selection of at least one product from a user and program code for receiving from the user search condition associated with said at least one product;
a memory for storing and maintaining said search condition associated with said at least one product, said search condition including at least one website to be searched for product information of said at least one product;
a product information search component configured to periodically search said at least one website for the product information of the at least one product based upon said search condition and storing search result of said periodical search; and
a product information processing component configured to present to the user personalized product information corresponding to the search condition based on said search result and said search condition.

22. The computing system of claim 21, wherein the user is allowed to select the at least one product by utilizing a drag-and-drop graphical user interface.

23. The computing system information of claim 22, wherein the client comprises:
an extraction component configured to extract at least one of a product code, a product name, and a model name of the at least one product from at least one of graphical image and text selected by the user by utilizing a drag-and-drop graphical user interface.

24. The computing system of claim 21, wherein said search condition includes at least one of price range of said at least one product and time interval for said periodical search, and
the product information search component comprises:
an access component configured to access said at least one website at each time interval; and
a search component configured to search said at least one website for the product information.

25. The computing system of claim 21, wherein said search condition includes at least one of a price range for said at least one product and a condition character string associated with the at least one product, and
the product information processing component comprises:
a condition data verification component configured to verify whether the search result meets said price range; and
a display component configured to display the personalized product information including product information based on said search result and said price range of the search condition.

26. A computing system for providing personalized product information to a user, comprising:
a client computer operative to execute program code for receiving selection of at least one content from a user and program code for receiving from the user search condition associated with said at least one content;
a memory for storing and maintaining said search condition associated with said at least one content, said search condition including at least one website to be searched for content information of said at least one content;
a content information search component configured to periodically search said at least one website for content information associated with the at least one content based upon said search condition and storing search result of said periodical search; and
a content information processing component configured to present to the user personalized content information based on the search condition.

27. The computing system of claim 26, wherein the user is allowed to select the at least one product by utilizing a drag-and-drop graphical user interface.

28. The computing system of claim 26, wherein
the content information search component comprises:
an access component configured to access said at least one website at each time interval; and
a search component configured to search said at least one website for the content information.

29. The computing system of claim 26, wherein the search condition includes at least one of a character string and a number entered by the user, and a relation between the number and the content information, and the content information processing component displays, from among the content information in which information is uploaded or changed from a previous search, content information including at least one of the character string and the number, or displays content information satisfying the relation between the number and the content information.
